(19) United States
(12) Patent Application Publication
(10) Pub. No.: US 2016/0233804 A1
(43) Pub. Date: Aug. 11, 2016

(54) MOTOR CONTROL DEVICE

(71) Applicant: MITSUBISHI ELECTRIC CORPORATION, Tokyo (JP)

(72) Inventors: Shinichi FURUTANI, Tokyo (JP); Shuya SANO, Tokyo (JP); Keita HORII, Tokyo (JP); Hiroto TAKEI, Tokyo (JP); Kazuya INAZUMA, Tokyo (JP)

(73) Assignee: Mitsubishi Electric Corporation, Tokyo (JP)

(21) Appl. No.: 15/024,060

(22) PCT Filed: Oct. 22, 2013
(86) PCT No.: PCT/JP2013/078590

§ 371 Date: Mar. 23, 2016

(51) Int. Cl. H02P 6/18; H02P 6/17

(52) U.S. Cl. CPC H02P 6/181; H02P 6/18; H02P 6/17

(57) ABSTRACT

A motor control device includes a motor-speed detection unit detecting and outputting a detected motor speed based on an output signal of an encoder connected to a motor that is a synchronous motor; a motor electric-angle detection unit detecting and outputting a detected motor electric angle based on the output signal; a motor electric-angle estimation unit receiving a motor voltage, a motor current, and the detected motor speed, and estimating and outputting an estimated motor electric angle based on the motor voltage and the motor current; and a switching unit receiving the detected motor electric angle and the estimated motor electric angle, determining whether the encoder is operating normally based on the detected motor electric angle and the estimated motor electric angle, outputting the detected motor electric angle when the encoder is operating normally, and outputting the estimated motor electric angle when the encoder is not operating normally.

### FIELD

The present invention relates to a motor control device.

### BACKGROUND

Permanent-magnet synchronous motors, winding-field synchronous motors, and synchronous reluctance motors are well known types of conventional synchronous motors in which the rotor synchronizes with the frequency of the stator current or the stator voltage.

For example, Patent Literature 1 discloses a technique for estimating the electric angle on the basis of the induced voltage of the motor and performing fault determination by using the estimated electric angle in accordance with an electric circuit model. Generally, the induced voltage of a motor has a larger amplitude as the motor speed increases. On the contrary, when the motor speed is low, the amplitude of the induced voltage is small and it is thus affected by voltage disturbances, such as an inverter dead time, and switching noise, thereby considerably reducing the accuracy of the estimated electric angle. Therefore, the technique described in Patent Literature 1 is such that when the motor accelerates for a certain time to reach the speed that is equal to or higher than a threshold or higher, estimation of the electric angle is performed.

### CITATION LIST

### Patent Literature

Patent Literature 1: Japanese Patent Application Laid-open No. 2010-029031

### SUMMARY

### Technical Problem

However, according to the above conventional technique, a certain time is required after the motor starts accelerating until the estimation of the electric angle is performed. Therefore, there is a problem in that detection of a disk displacement fault is delayed.

The disk displacement fault may occur before a motor control device is activated. Therefore, unless it is determined whether disk displacement has occurred when the motor starts operating, the motor will rotate in an unintended direction synchronously with the activation of the motor. In the case where the synchronous motor is used as a source of a driving force of some mechanism (e.g., a robot or a feed mechanism), when such a fault occurs, the mechanism operates abnormally due to the unintended rotation. Consequently, the mechanism itself or other objects present near the mechanism may be broken, and thus the motor needs to be stopped as quickly as possible.

A technique exists for estimating the electric angle and the electric angle frequency of a motor when the motor speed is low by utilizing salient-pole properties where the inductance value viewed from the stator side changes depending on the rotation position of the motor without utilizing the induced voltage of a motor. This technique cannot be used with a motor that does not have salient-pole properties (e.g., a surface permanent magnet motor).

The present invention has been achieved in view of the above problems, and an object of the present invention is to provide a motor control device that can detect a disk displacement fault immediately after starting an operation in order to reduce an abnormal operation, even in the case of a synchronous motor that does not have salient-pole properties.

### Solution to Problem

In order to solve the above problems and achieve the object, an aspect of the present invention is a motor control device that controls a synchronous motor that does not have a salient-pole property, the motor control device including: a motor-speed detection unit that detects a speed of a motor on a basis of an output signal of an encoder (position sensor) connected to the motor that is a synchronous motor and that outputs a detected motor speed of the motor; a motor electric-angle detection unit that detects an electric angle of the motor on a basis of the output signal of the encoder and outputs a detected motor electric angle; a motor electric-angle estimation unit that receives a motor voltage of the motor, a motor current of the motor, and the detected motor speed, estimates an electric angle of the motor on a basis of the motor voltage and the motor current, and outputs an estimated motor electric angle; and a switching unit that receives the detected motor electric angle and the estimated motor electric angle, determines whether the encoder is operating normally on a basis of the detected motor electric angle and the estimated motor electric angle, outputs the detected motor electric angle when the encoder is operating normally, and outputs the estimated motor electric angle when the encoder is not operating normally.

### Advantageous Effects of Invention

According to the motor control device of the present invention, an effect is obtained where it is possible to provide a motor control device that can detect a disk displacement fault immediately after starting an operation in order to reduce an abnormal operation, even in the case of a synchronous motor that does not have salient-pole properties.

### BRIEF DESCRIPTION OF DRAWINGS

FIG. 1-1 is a diagram illustrating an example of the configuration of a motor control device according to a first embodiment.

FIG. 1-2 is a diagram illustrating the configuration of a motor control device as a comparative example.

FIG. 2-1 is a diagram illustrating an example of the configuration of an electric-angle estimation unit of the motor control device according to the first embodiment.

FIG. 2-2 is a diagram illustrating the configuration of an electric-angle estimation unit of the motor control device as a comparative example.

FIG. 2-3 is a diagram illustrating an example of the configuration of an electric-angle estimation unit of a motor control device according to a third embodiment.

### DESCRIPTION OF EMBODIMENTS

Exemplary embodiments of a motor control device according to the present invention will be explained below in detail with reference to the accompanying drawings. The present invention is not limited to the embodiments.

### First Embodiment

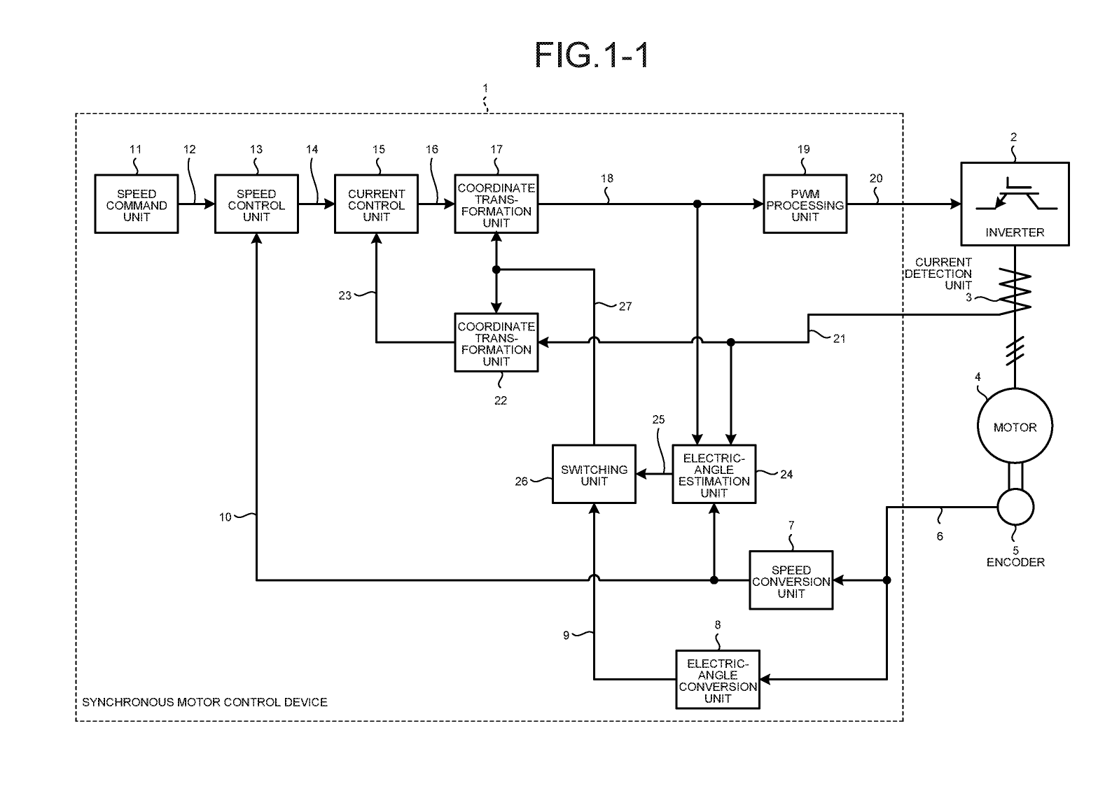

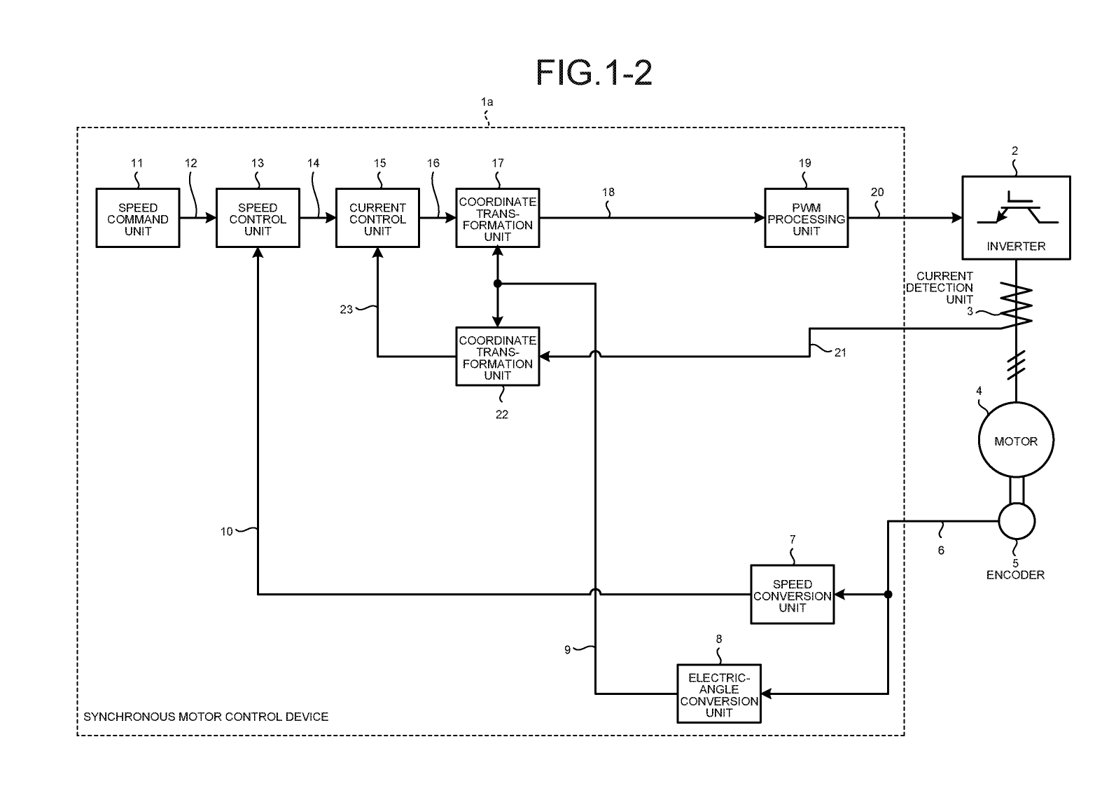

FIG. 1-1 is a diagram illustrating an example of the configuration of a motor control device according to a first embodiment of the present invention. A synchronous motor control device 1 illustrated in FIG. 1-1 is connected to an inverter 2, a current detection unit 3, and an encoder 5 (a position sensor). The inverter 2 and the encoder 5 are connected to a motor 4, and the current detection unit 3 is provided between the inverter 2 and the motor 4. The motor 4 used, for example, is a permanent-magnet synchronous motor.

The synchronous motor control device 1 illustrated in FIG. 1-1 includes a speed command unit 11, a speed control unit 13, a current control unit 15, coordinate transformation units 17 and 22, a PWM processing unit 19, a speed conversion unit 7, an electric-angle conversion unit 8, an electric-angle estimation unit 24, and a switching unit 26.

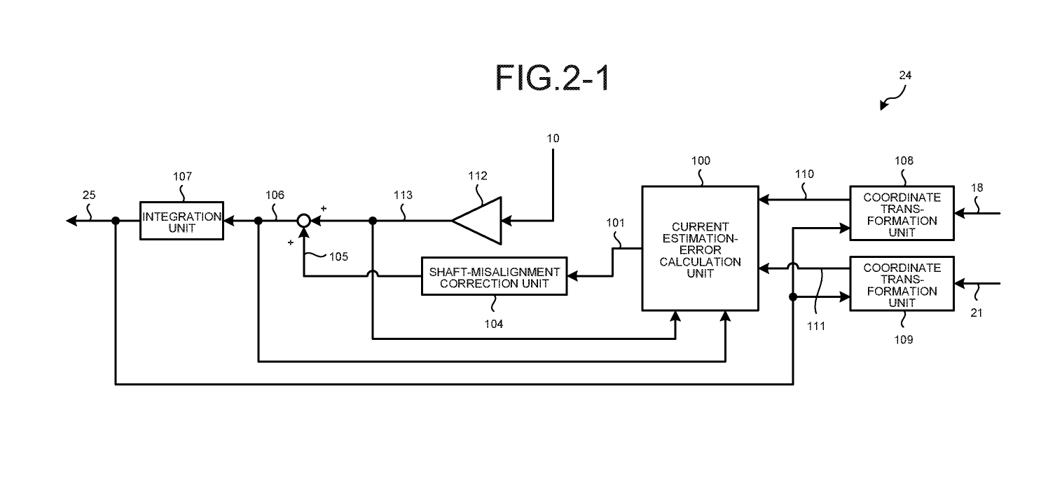

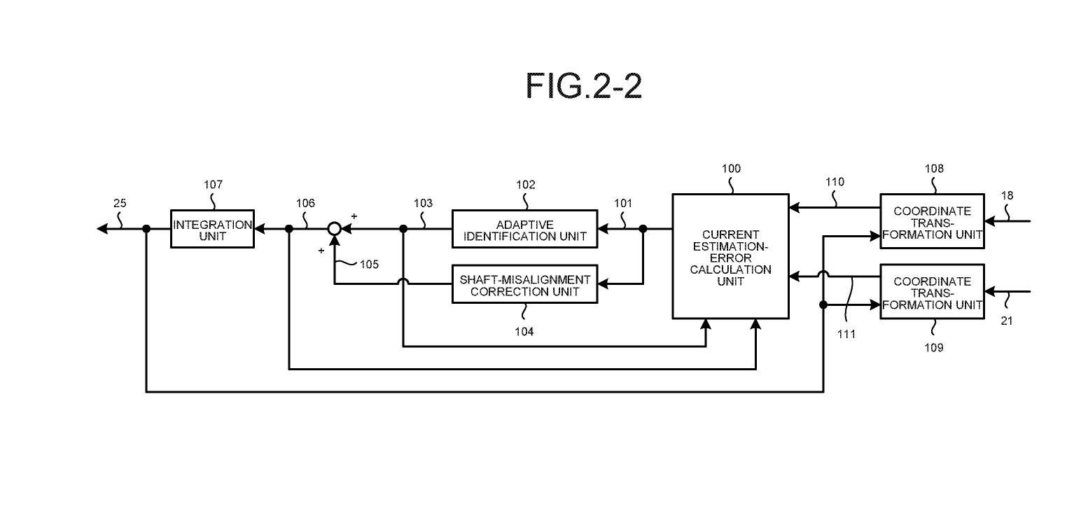

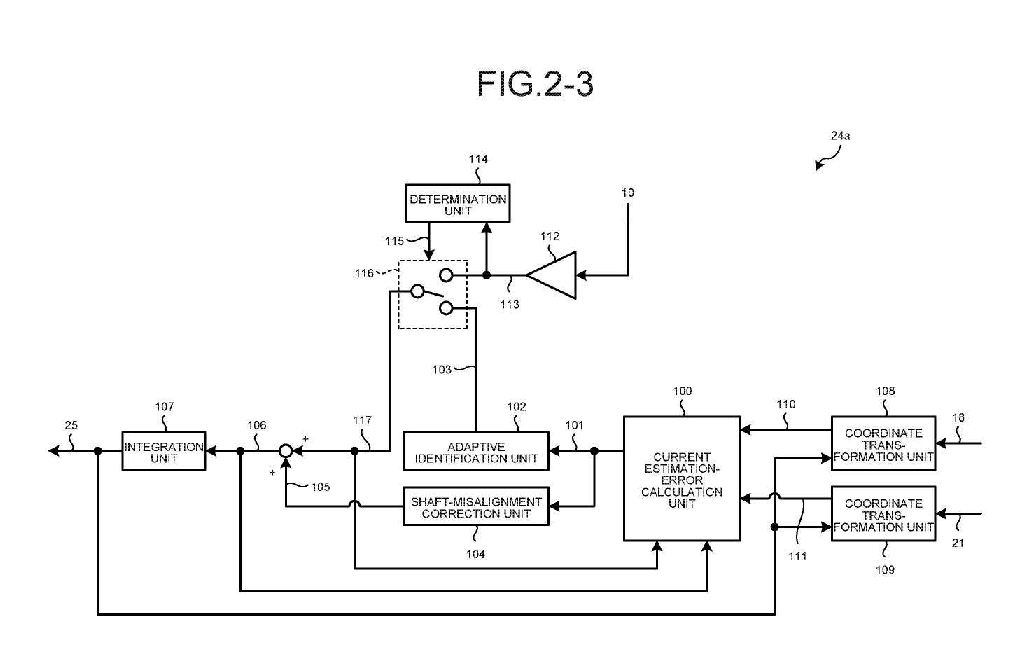

The configuration of a conventional motor control device is described. FIG. 1-2 is a diagram illustrating the configuration of a conventional motor control device as a comparative example. Similarly to the synchronous motor control device 1 illustrated in FIG. 1-1, a synchronous motor control device 1a illustrated in FIG. 1-2 is also connected to the inverter 2, the current detection unit 3, and the encoder 5, the inverter 2 and the encoder 5 are connected to the motor 4, and the current detection unit 3 is provided between the inverter 2 and the motor 4.

The synchronous motor control device 1a includes a control unit, a processing unit, a conversion unit, and a transformation unit. These units are configured such that the output values are input again via another control unit, processing unit, conversion unit, or transformation unit.

The encoder 5 outputs an encoder signal 6. The encoder signal 6 corresponds to rotor position (angle) information regarding the motor 4. The encoder signal 6 is input to the speed conversion unit 7 and the electric-angle conversion unit 8.

The speed conversion unit 7 performs differential processing on the encoder signal 6 or takes a difference between the encoder signals 6 to output the rotation speed of the rotor of the motor 4 as a speed signal 10. The speed signal 10 is input to the speed control unit 13.

The speed signal 10 and a speed command 12 output from the speed command unit 11 are input to the speed control unit 13. The speed control unit 13 executes control processing such that the speed signal 10 matches the speed command 12 and then outputs a current command 14. The speed control unit 13 executes, for example, PI (proportional integral) control and feed forward control.

In order to control the speed of a synchronous motor, the torque of the synchronous motor is controlled. In the permanent-magnet synchronous motor used herein as an example, the motor torque is proportional to the motor current; therefore, the output of the speed control unit 13 becomes a current command. The current command 14 is input to the current control unit 15.

A current control system including the current control unit 15 and the coordinate transformation unit 17 is established on biaxial orthogonal rotational coordinates (dq-axes). In most cases, the d-axis is set in the rotor flux direction of the motor, and at this time, the q-axis current becomes a current that generates motor torque. Therefore, the current command 14 output from the speed control unit 13 corresponds to a q-axis current command.

The current control unit 15 executes PI control and decoupling control that suppresses electromagnetic interference between the dq-axes of the motor 4. The current command 14 and a detected current signal 23 on the rotational coordinates are input to the current control unit 15, and the current control unit 15 executes control processing and outputs a voltage command 16.

The detected current signal 23 on the rotational coordinates is a signal on the dq-axes. A detected current signal 21 on three-phase stationary coordinates is input to the coordinate transformation unit 22 and the detected current signal 23 is calculated by using the following equation (1). The detected current signal 21 on the three-phase stationary coordinates is output from the current detection unit 3.

$$[ \begin{matrix}{I}_{d} \\ {I}_{q}\end{matrix} ] = \sqrt{\frac{2}{3}} \cdot [ \begin{matrix}cos ( {θ}_{e} ) & sin ( {θ}_{e} ) \\ sin ( {θ}_{e} ) & cos ( {θ}_{e} )\end{matrix} ] [ \begin{matrix}1 & - \frac{1}{2} & - \frac{1}{2} \\ 0 & \frac{\sqrt{3}}{2} & - \frac{\sqrt{3}}{2}\end{matrix} ] [ \begin{matrix}{I}_{u} \\ {I}_{v} \\ {I}_{w}\end{matrix} ] \qquad ( 1 )$$

In the equation (1), I_{d} and I_{q} correspond to the detected current signal 23 on the rotational coordinates, and Iᵤ, Iᵥ, and I_{w} correspond to the detected current signal 21 on the three-phase stationary coordinates. In the equation (1), θe is a detected electric angle and corresponds to an electric angle 9, which is a phase signal indicating the angle of the motor rotor flux. The electric angle 9 is output from the electric-angle conversion unit 8 that has received the encoder signal 6 and input to the coordinate transformation units 17 and 22.

A coefficient √(⅔) and two matrixes (a matrix of two rows and two columns and a matrix of two rows and three columns) correspond to a transformation coefficient from the three-phase stationary coordinates to the rotational coordinates. The detected current signal 23 on the rotational coordinates is input to the current control unit 15. Therefore, the voltage command 16 output from the current control unit 15 is a signal on the rotational coordinates (dq-axes).

The coordinate transformation unit 17 transforms the input voltage command 16 to a voltage command on the three-phase stationary coordinates by using the following equation (2) and outputs the transformed voltage command as a voltage command 18.

$$[ \begin{matrix}{V}_{u}^{*} \\ {V}_{v}^{*} \\ {V}_{w}^{*}\end{matrix} ] = \sqrt{\frac{2}{3}} \cdot [ \begin{matrix}1 & 0 \\ - \frac{1}{2} & \frac{\sqrt{3}}{2} \\ - \frac{1}{2} & - \frac{\sqrt{3}}{2}\end{matrix} ] [ \begin{matrix}cos ( {θ}_{e} ) & - sin ( {θ}_{e} ) \\ sin ( {θ}_{e} ) & cos ( {θ}_{e} )\end{matrix} ] [ \begin{matrix}{V}_{d}^{*} \\ {V}_{q}^{*}\end{matrix} ] \qquad ( 2 )$$

In the equation (2), V_{d*} and V_{q*} correspond to the voltage command 16, and V_{u*}, V_{v*}, and V_{w*} correspond to the voltage command 18.

The PWM processing unit 19 converts the voltage command 18 to a switching command 20 and outputs the switching command 20. The inverter 2 that has received the switching command 20 operates according to the switching command 20 and outputs, to the motor 4, a voltage according to the voltage command 18.

The electric angle 9 input to the coordinate transformation unit 17 and the coordinate transformation unit 22 is determined by the rotor flux phase of the synchronous motor. Specifically, the electric angle 9 is determined such that the vector direction of the rotor flux becomes the d-axis.

In a motor in which the number of poles is P, the electric angle rotates a multiple of the number of pole pairs, i.e., P/2 times, with respect to one rotation of the motor rotor. The encoder 5 is attached to the shaft of the motor rotor after it is adjusted such that the zero phase of the encoder signal 6 matches any of the zero phases of the electric angle, the number of which is equal to the number of pole pairs. At this time, if it is assumed that the encoder signal 6 is denoted by θ, the electric angle 9 is denoted by θe, and the number of poles of the motor is P, then the electric angle 9 is expressed by the following equation (3).

$${θ}_{e} = \frac{P}{2} \cdot θ \qquad ( 3 )$$

Similarly, regarding the speed signal 10 and the electric angle frequency, being differential values of the encoder signal 6 and the electric angle 9, respectively, if it is assumed that the speed signal 10 is denoted by ωᵣ and the electric angle frequency is denoted by ωᵣₑ, the relation given by the following equation (4) is established.

$${ω}_{re} = \frac{P}{2} \cdot {ω}_{r} \qquad ( 4 )$$

The encoder 5 is described next. The configuration of the encoder 5 includes a disk directly connected to the rotor shaft of the motor 4 and a peripheral circuit part connected to the stator. Because the disk is directly connected to the rotor shaft, the disk rotates with the rotation of the motor 4. For example, when the encoder 5 is an optical encoder, a slit and a reflection structure corresponding to the angle in the disk are provided on the disk directly connected to the rotor shaft, and by irradiating the disk with light, the peripheral circuit part connected to the stator reads the angle in the disk according to the presence or absence of reflection or transmission of light. Because the disk is connected to the motor rotor shaft with a fixed positional relation, conversion to the position of the motor rotor shaft from the angle in the disk is easy. The peripheral circuit part connected to the stator performs processing and outputs a rotor position of the motor 4.

An example in which the encoder 5 is an optical encoder has been described. However, the encoder 5 is not limited thereto, and encoders of other types can be used. Examples of the encoders of other types include an encoder that reads the angle in the disk by using magnetism.

As described above, it is satisfactory if the encoder 5 is of a type that rotates according to the motor rotor shaft and reads the angle in the disk from outside in a non-contact manner relative to an object on which its own angle information is described, thereby outputting the angle as a position signal.

The encoder 5 used in this manner may have a fault. Examples of such a fault mode include disconnection of a sensor cable and a soldering crack in a peripheral circuit part due to heat from the motor or periphery thereof or self-heating. Among such faults, a fault referred to as “disk displacement” is difficult to detect.

Disk displacement is a phenomenon that occurs when the rotor shaft of the motor and the disk are temporarily detached from each other, e.g., due to an impact and then re-fixed, and it means that the re-fixed position deviates from the original connection position.

In this manner, if the rotor shaft of the motor and the disk are fixed at a position deviated from the original connection position, the rotation angle information from the encoder 5 has an offset error with respect to the true motor rotor position. In contrast to detecting a soldering crack or disconnection of a sensor cable, electrically detecting the disk displacement is difficult. Further, in the case of the disk displacement, because it appears that the encoder signal is output normally, it is also difficult to perform detection on the basis of an encoding process in which, for example, a parity check of the signal data is performed.

In this manner, disk displacement, which is difficult to detect, affects the signal in the synchronous motor control device 1. Calculation of the speed signal 10 is not much affected. This is because the speed signal 10 is generated by performing a process equivalent to differential processing on the encoder signal 6, and thus, even if an offset error is included in the encoder signal 6, the speed signal 10 does not include the offset error. However, the current control system provided inside the speed control system is significantly affected by the disk displacement, and it makes a normal operation difficult. As a result, a normal operation of the speed control system becomes difficult.

Generally, the electric angle of the motor rotates a multiple of the number of pole pairs with respect to one rotation of the motor. Therefore, the offset error due to the disk displacement is amplified several times during the electric angle conversion. For example, in an 8-pole permanent-magnet synchronous motor, when the electric angle is output with an offset error of 30 degrees from the encoder 5 relative to the shaft position of the motor rotor due to a disk displacement fault, the error is amplified to 8/2, i.e., to four times in the electric angle, and the offset error becomes 30×4=120 degrees.

If the electric angle error is less than 90 degrees, I_{d} flows instead of I_{q}. Therefore, the motor torque decreases due to a decrease of true I_{q} flowing to the motor, or voltage saturation occurs due to a strong magnetic flux due to an increase of I_{d}, thereby causing a decrease in current control response. Further, there is armature reaction in the motor, and the motor current is suppressed also by the voltage saturation itself, and thus a decrease in the motor torque may occur. That is, if the electric angle error is less than 90 degrees, the torque characteristics of the motor decrease. This becomes more conspicuous as the electric angle error increases.

If the electric angle error exceeds 90 degrees, polarity reversal occurs in the true I_{q} flowing to the motor and I_{q} in the control device. For example, if the value of the electric angle error reaches 180 degrees (π[rad]), the coordinate transformation equation becomes the following equation (5).

$$\begin{matrix}[ \begin{matrix}{I}_{d} \\ {I}_{q}\end{matrix} ] = \sqrt{\frac{2}{3}} \cdot [ \begin{matrix}cos ( {θ}_{eE} ) & sin ( {θ}_{eE} ) \\ - sin ( {θ}_{eE} ) & cos ( {θ}_{eE} )\end{matrix} ] [ \begin{matrix}1 & - \frac{1}{2} & - \frac{1}{2} \\ 0 & \frac{\sqrt{3}}{2} & - \frac{\sqrt{3}}{2}\end{matrix} ] [ \begin{matrix}{I}_{u} \\ {I}_{v} \\ {I}_{w}\end{matrix} ] \\ = \sqrt{\frac{2}{3}} \cdot [ \begin{matrix}cos ( {θ}_{e} + π ) & sin ( {θ}_{e} + π ) \\ - sin ( {θ}_{e} + π ) & cos ( {θ}_{e} + π )\end{matrix} ] [ \begin{matrix}1 & - \frac{1}{2} & - \frac{1}{2} \\ 0 & \frac{\sqrt{3}}{2} & - \frac{\sqrt{3}}{2}\end{matrix} ] [ \begin{matrix}{I}_{u} \\ {I}_{v} \\ {I}_{w}\end{matrix} ] \\ = \sqrt{\frac{2}{3}} \cdot [ \begin{matrix}- cos ( {θ}_{e} ) & - sin ( {θ}_{e} ) \\ sin ( {θ}_{e} ) & - cos ( {θ}_{e} )\end{matrix} ] [ \begin{matrix}1 & - \frac{1}{2} & - \frac{1}{2} \\ 0 & \frac{\sqrt{3}}{2} & - \frac{\sqrt{3}}{2}\end{matrix} ] [ \begin{matrix}{I}_{u} \\ {I}_{v} \\ {I}_{w}\end{matrix} ]\end{matrix} \qquad ( 5 )$$

In this equation, θ_{eE} is an electric angle including an error.

As is obvious from comparison of the equation (1) and the equation (5), if the electric angle error is 180 degrees, polarity reversal occurs in the current after the coordinate transformation. This means that even if the control device attempts to cause the torque current I_{q} to flow in order to accelerate the synchronous motor, in practice, the I_{q} of the synchronous motor becomes a current component in a deceleration direction, and thus acceleration cannot be performed or the motor rotates in an unintended direction.

With respect to such disk displacement, a method based on estimation of the electric angle of the motor is effective. First, an electric circuit model of the motor is built in the control device, and a voltage signal and a current signal of the motor are input to the control device. An induced voltage of the motor is then calculated by using these signals and the electric circuit model, and an electric angle is estimated therefrom. The induced voltage is generated due to rotation of the rotor flux of the motor, and it becomes a 90-degree leading component with respect to the rotor flux. If the phase of the induced voltage can be calculated, the phase of the rotor flux can also be calculated. The phase of the rotor flux corresponds to the electric angle. In this manner, by estimating the electric angle from the induced voltage and comparing the estimated electric angle with the detected electric angle obtained by the encoder 5, the disk displacement fault of the encoder 5 can be determined.

Therefore, in the present invention, the synchronous motor control device 1 illustrated in FIG. 1-1 that can estimate the electric angle is used. The synchronous motor control device 1 illustrated in FIG. 1-1 is different from the conventional synchronous motor control device 1a illustrated in FIG. 1-2 in that the synchronous motor control device 1 includes the electric-angle estimation unit 24 and the switching unit 26.

The electric-angle estimation unit 24 uses a method generally known as sensorless control in the motor control method, and mainly includes a flux observer derived from a circuit equation of the permanent-magnet synchronous motor and a configuration for estimating the electric angle frequency. The general sensorless control using the flux observer is described here.

Calculation of the flux observer uses the electric angle frequency of the motor. In this description, with the sensorless control, the true electric angle frequency is unknown, and thus an estimated electric-angle frequency is used. The sensorless control method described above calculates an estimated current of the permanent-magnet synchronous motor on the basis of the estimated flux estimated from the flux observer. Regarding an error between the estimated current and the detected current, feedback correction of the estimated electric-angle frequency is performed on the basis of the concept of adaptive identification, where it is assumed that there is an error in the estimated electric-angle frequency used in the calculation of the flux observer. Because the electric angle frequency of the motor becomes a multiple of the number of pole pairs of the rotor speed of the motor, a value obtained by dividing the estimated electric-angle frequency by the number of pole pairs becomes an estimated value of the motor rotor speed. Further, the estimated electric angle can be obtained by performing integration on the estimated electric-angle frequency.

FIG. 2-2 is a diagram illustrating an example of the configuration of the electric-angle estimation unit that estimates the electric angle frequency by using the flux observer. The electric-angle estimation unit illustrated in FIG. 2-2 includes a current estimation-error calculation unit 100, an adaptive identification unit 102, a shaft-misalignment correction unit 104, an integration unit 107, and coordinate transformation units 108 and 109. The current estimation-error calculation unit 100 calculates an estimation error of the q-axis current as described above.

The current estimation-error calculation unit 100 performs calculations using the following equations (6) to (8). The flux observer is obtained by using the equation (6).

$$\begin{matrix}\frac{d}{d t} [ \begin{matrix}{Φ}_{ds\_est} \\ {Φ}_{qs\_est} \\ {Φ}_{dr\_est}\end{matrix} ] = [ \begin{matrix}{Φ}_{ds\_est} \\ {Φ}_{qs\_est} \\ {Φ}_{dr\_est}\end{matrix} ] [ \begin{matrix}- \frac{R}{{L}_{d}} & {ω}_{\_ est} & 0 \\ - {ω}_{\_ est} & - \frac{R}{{L}_{q}} & - {ω}_{re \_ est} \\ 0 & 0 & 0\end{matrix} ] [ \begin{matrix}{Φ}_{ds\_est} \\ {Φ}_{qs\_est} \\ {Φ}_{dr\_est}\end{matrix} ] + [ \begin{matrix}{V}_{ds} \\ {V}_{qs} \\ 0\end{matrix} ] - [ \begin{matrix}{h}_{11} & {h}_{12} \\ {h}_{21} & {h}_{22} \\ {h}_{31} & {h}_{32}\end{matrix} ] [ \begin{matrix}Δ {I}_{ds} \\ Δ {I}_{qs}\end{matrix} ] & ( 6 ) \\ [ \begin{matrix}{I}_{d \_ est} \\ {I}_{qs \_ est}\end{matrix} ] = [ \begin{matrix}\frac{1}{{L}_{d}} & 0 & 0 \\ 0 & \frac{1}{{L}_{q}} & 0\end{matrix} ] [ \begin{matrix}{Φ}_{ds\_est} \\ {Φ}_{qs\_est} \\ {Φ}_{dq\_est}\end{matrix} ] & ( 7 ) \\ [ \begin{matrix}Δ {I}_{ds} \\ Δ {I}_{qs}\end{matrix} ] = [ \begin{matrix}{I}_{d \_ est} - {I}_{ds} \\ {I}_{qs \_ est} - {I}_{qs}\end{matrix} ] & ( 8 )\end{matrix}$$

In this equation, φ_{ds}_{_}ₑₛₜ a d-axis estimated stator flux, φ_{qs}_{_}ₑₛₜ is a q-axis estimated stator flux, and φ_{dr}_{_}ₑₛₜ is a d-axis estimated rotor flux. R is winding resistance, L_{d} is d-axis inductance, and L_{q} is q-axis inductance. Further, ω_{—est} is a post-correction estimated electric-angle frequency 106, and ωᵣₑ_{_}ₑₛₜ is an estimated electric-angle frequency 103. V_{ds} and V_{qs} are each a voltage command 110 (V_{ds} is a d-axis voltage and V_{qs} is a q-axis voltage). Further, h₁₁, h₁₂, h₂₁, h₂₂, h₃₁, and h₃₂ are feedback gain. ΔI_{ds} and ΔI_{qs} are each a current estimation error 101 (ΔI_{ds} is a d-axis current estimation error, and ΔI_{qs} is a q-axis current estimation error). I_{ds}_{_}ₑₛₜ is an estimated value of the d-axis current, and I_{qs}_{_}ₑₛₜ is an estimated value of the q-axis current. I_{ds} and I_{qs} are each a detected current signal 111 (I_{ds} is the d-axis current, and I_{qs} is the q-axis current).

The adaptive identification unit 102 performs processing on the input current estimation error 101, and outputs the estimated electric-angle frequency 103. The adaptive identification unit 102 executes PI control and performs calculation using the following equation (9).

ωᵣₑ_{_}ₑₛₜ=K₁·ΔI_{qs}+K₂·∫ΔI_{qs}·dt (9)

In this equation, K1 is an adaptive proportional gain, and K2 is an adaptive integral gain.

In order to perform correction of the estimated electric-angle frequency 103 so that the d-axis of the biaxial orthogonal rotational coordinates, on which the sensorless control system operates, matches the motor rotor flux, the shaft-misalignment correction unit 104 calculates ω_{cmp} by using the following equation (10) and outputs a correction signal 105.

$${ω}_{cmp} = - \frac{{h}_{41} \cdot Δ {I}_{ds} + {h}_{42} \cdot Δ {I}_{qs}}{{Φ}_{dr \_ est}} \qquad ( 10 )$$

In this equation, h₄₁ and h₄₂ are each feedback gain. An estimated electric angle 25 can be obtained by the integration unit 107 performing integration processing on the estimated electric-angle frequency 103 and the correction signal 105.

In the calculation performed by the current estimation-error calculation unit 100, the motor voltage and the motor current are required as represented by the above equation, and the calculation is performed by coordinate transformation by using the detected current signal 21 and the estimated electric angle 25 from the voltage command 18.

In this manner, when the electric-angle estimation unit has a configuration that does not use the information on the encoder signal 6, the estimated electric angle 25 can be used as a substitute for the electric angle 9 when the encoder has a fault.

The motor voltage is used for calculation of the flux observer. However, in most cases, the voltage command 18 is used instead. However, there is an error between the voltage command 18 and the voltage applied to the motor in practice, due to an inverter dead time and forward voltage effect of a power module. Further, in a low-speed operating range with the induced voltage of the motor being small, sensitivity of the voltage error increases relatively and estimation accuracy of the electric angle frequency and the electric angle considerably decreases. Therefore, the estimated electric angle and electric angle frequency cannot be used until a certain time has passed after the motor starts accelerating.

Therefore, in the present invention, an electric angle is estimated, not by estimating the electric angle frequency, but instead by using an electric angle frequency obtained from the encoder signal 6 by utilizing the property of the disk displacement fault of the encoder that can use only the speed information. That is, the electric-angle estimation unit 24 illustrated in FIG. 2-1 is used.

FIG. 2-1 illustrates an example of the configuration of the electric-angle estimation unit 24. The electric-angle estimation unit 24 illustrated in FIG. 2-1 includes a gain 112 instead of the adaptive identification unit 102. The speed signal 10 is input to the gain 112. The gain 112 that has received the speed signal 10 outputs an electric angle frequency 113. The gain 112 is the number of pole pairs and corresponds to the calculation performed using the equation (4). The output electric angle frequency 113 is used for calculating the estimated electric angle 25, instead of the estimated electric-angle frequency 103 in FIG. 2-2.

If the electric-angle estimation unit 24 has the configuration illustrated in FIG. 2-1, the estimated electric angle 25 can be obtained even in a low-speed operating range from the time of activation of the motor without waiting for an increase of the motor rotation speed.

Therefore, as described above, an estimated electric angle signal can be supplied earlier in time with respect to the disk displacement fault that has already occurred at the time of activation of the motor, thereby enabling the response characteristics in detection of a disk displacement fault to be improved.

Furthermore, even in a low-speed operating range of the motor, current control of the motor after detection of the encoder fault can be continued, thereby enabling an abnormal operation of the motor at the time of an encoder fault to be suppressed more than in the conventional case as well as enabling the response characteristics in fault detection to be improved. Accordingly, an abnormal operation can be eliminated and thus breakage of a mechanism using the motor as a driving source and an object present near the mechanism can be prevented.

In FIG. 2-2, the configuration is such that the estimated electric-angle frequency 103 is fed back to the flux observer. Therefore, the estimated electric-angle frequency 103 causes a time delay with respect to the true electric angle frequency. However, with the configuration of FIG. 2-1, the response characteristics of the estimated electric angle 25 are improved, and as a result, an abnormal operation of the motor at the time of an encoder fault can be suppressed more than in the conventional case.

The switching unit 26 is described next. The switching unit 26 compares the estimated electric angle 25 with the electric angle 9. When it is determined that the operation of the encoder is normal, the switching unit 26 allocates the electric angle 9 to a coordinate-transformed electric angle 27. In this manner, even if a disk displacement fault occurs, synchronous motor current control can be continued.

In particular, when the motor is to be stopped urgently, a torque current in a deceleration direction can be caused to flow to the motor by utilizing the estimated electric angle 25. Accordingly, as compared to a case where a power supply line of the motor is short-circuited to perform braking, the motor can be stopped in an extremely short time.

When the switching unit 26 performs fault detection, it is determined that a disk displacement fault has occurred by utilizing the fact that the error between the estimated electric angle 25 and the electric angle 9 has a constant value (an offset value). Specifically, if the error is equal to or larger than a threshold and the state thereof continues for equal to or more than a set time, it is determined that a disk displacement fault has occurred. With this configuration, erroneous abnormality determination can be prevented.

In the flux observer described above, the voltage command is used instead of the motor voltage. However, because the current control system operates to cancel the effect of an inverter dead time and forward voltage drop of the power module or other noise, the voltage command may include vibrational components based thereon. Therefore, the estimated electric angle 25 by the flux observer may pulsate, and may transiently exceed the threshold of a phase estimation error. As described above, by waiting for a set time, some temporal loss occurs until detection is performed. However, occurrence of erroneous fault detection can be suppressed, thereby enabling the reliability of the device to be improved.

As described above, according to the present embodiment, by using encoder speed information during estimation of the electric angle of the motor, estimation of the electric angle of the motor can be performed even in a low-speed operating range from the time of activation of the motor even when the encoder has a disk displacement fault. Further, because the estimation responsiveness of the electric angle of the motor can be improved, the time required until a fault is detected can be reduced, thereby enabling an abnormal operation of the motor to be suppressed.

### Second Embodiment

In the first embodiment, the configuration of the electric-angle estimation unit 24 is based on the flux observer. However, the present embodiment has a configuration in which the electric-angle estimation unit estimates the electric angle by obtaining an induced voltage from a motor voltage and a motor current. The circuit equation of a permanent-magnet synchronous motor is represented by the following equation (11). The equation (11) is an equation on rotational coordinates.

$$[ \begin{matrix}{V}_{dd} \\ {V}_{qq}\end{matrix} ] = [ \begin{matrix}R + p \cdot L & - {ω}_{re} \cdot L \\ {ω}_{re} \cdot L & R + p \cdot L\end{matrix} ] [ \begin{matrix}{I}_{dd} \\ {I}_{qq}\end{matrix} ] + [ \begin{matrix}{E}_{dd} \\ {E}_{qq}\end{matrix} ] \qquad ( 11 )$$

In this equation, the subscript is dd and qq. This is to discriminate it from general biaxial orthogonal rotational coordinates in which the motor rotor flux matches the d-axis. That is, the dd-axis and the qq-axis are axes of the biaxial orthogonal rotational coordinates, but have a phase difference from the d-axis and the q-axis. Further, R is winding resistance of the motor, L is inductance, ωᵣₑ is an electric angle frequency, and p is a differential operator. The voltage command 18 and the detected current signal 21 are on three-phase stationary coordinates. If coordinate transformation expressed in the equation (1) is applied according to the estimated electric angle, V_{dd}, V_{qq}, I_{dd}, and I_{qq} can be obtained. If these are substituted in the equation (11), induced voltages E_{dd} and E_{qq} are obtained.

When the motor rotor flux matches the d-axis, the induced voltage appears only on the q-axis. That is, if the induced voltage value of the dd-axis becomes zero, it can be determined that the dd-axis matches the d-axis. Therefore, the phase for the coordinate transformation is corrected by a phase correction term θ_{c} calculated by the following equation (12).

$${θ}_{c} = {tan}^{- 1} ( \frac{{E}_{qq}}{{E}_{dd}} ) \qquad ( 12 )$$

If a phase obtained by simply integrating the electric angle calculated from the encoder signal is assumed to be θ_{B}, θ_{B} can be represented by the equation (13).

θ_{B}=∫ωᵣₑ·dt (13)

The estimated electric angle of the motor θₑ_{_}ₑₛₜ at the time of normal rotation of the motor can be obtained by the equation (14), and the estimated electric angle of the motor θₑ_{_}ₑₛₜ at the time of reverse rotation of the motor can be obtained by the equation (15).

$$\begin{matrix}{θ}_{e \_ est} = {θ}_{B} + {θ}_{C} - \frac{π}{2} & ( 14 ) \\ {θ}_{e \_ est} = {θ}_{B} + {θ}_{C} + \frac{π}{2} & ( 15 )\end{matrix}$$

The estimation method of the electric angle by the flux observer described in the first embodiment requires adjustment when setting each gain. However, the configuration for estimating the electric angle on the basis of the motor circuit equation eliminates the adjustment element, and thus the electric-angle estimation unit 24 can be easily configured. The essential function thereof with respect to detection of a disk displacement fault of the encoder is the same as that in the first embodiment, and similar effects can be obtained.

### Third Embodiment

In the present embodiment, a motor control device that includes an electric-angle estimation unit 24a instead of the electric-angle estimation unit 24 in the first and second embodiments is described. The electric-angle estimation unit 24a can switch whether to use the speed signal 10 from the encoder of the electric-angle estimation unit. The motor control device has an identical configuration as that of the first and second embodiments except for the inclusion of the electric-angle estimation unit 24a instead of the electric-angle estimation unit 24.

FIG. 2-3 is a diagram illustrating the configuration of the electric-angle estimation unit 24a. The electric-angle estimation unit 24a illustrated in FIG. 2-3 is different from the electric-angle estimation unit 24 of the first and second embodiments in that a determination unit 114 and an electric-angle-frequency switching unit 116 are included therein.

The determination unit 114 calculates the absolute value of the electric angle frequency, and outputs an instruction signal 115 so as to allocate the estimated electric-angle frequency 103 to an electric-angle estimation-calculation electric-angle frequency 117 if the absolute value is equal to or larger than a threshold and so as to allocate the electric angle frequency 113 to the electric-angle estimation-calculation electric-angle frequency 117 if the absolute value is smaller than the threshold. With this configuration, an abnormality determination range at the time of a high-speed operation of the motor can be extended.

The electric-angle-frequency switching unit 116 performs a switching operation according to the instruction signal 115.

When estimation of the electric angle is to be performed without using the speed signal 10 from the encoder 5, as described above, the estimation accuracy of the electric angle increases as the motor rotation speed increases. Therefore, if the absolute value of the motor rotation speed is equal to or larger than a threshold, sustainable accuracy required for use in detection of a disk displacement fault of the encoder 5 can be obtained. Even if the rotation speed of the motor increases, the speed signal 10 from the encoder 5 can be continuously used.

However, when encoder information is used for estimation of the electric angle, if the encoder 5 has a fault due to other fault modes (e.g, disconnection of a sensor cable), it is impossible to address this fault.

Therefore, in the present embodiment, the electric angle frequency to be used for estimation of the electric angle is switched on the basis of the absolute value of the detection speed obtained from the encoder 5. When the absolute value of the electric angle frequency is smaller than a threshold, switching is performed so as to allocate the electric angle frequency 113 to the electric-angle estimation-calculation electric-angle frequency 117 and the electric angle frequency from the encoder 5 is used for estimation of the electric angle. When the absolute value of the electric angle frequency is equal to or larger than the threshold, switching is performed so as to allocate the estimated electric-angle frequency 103 to the electric-angle estimation-calculation electric-angle frequency 117 and estimation of the electric angle frequency is performed without using the electric angle frequency from the encoder 5, thereby estimating the electric angle.

With the configuration including the electric-angle estimation unit 24a, a disk displacement fault of the encoder at the time of a low speed including when the motor is activated can be detected, and a fault other than the disk displacement fault (e.g., disconnection of a sensor cable causing discontinuance of the encoder signal) of the encoder at the time of a high-speed operation of the motor can be also detected, thereby extending the application range of the electric-angle estimation unit and the switching unit.

The method of detecting a fault mode other than the encoder disk displacement is different depending on the waveform shape of the encoder signal 6 at the time of the encoder fault. When a value at the point in time when a fault has occurred is maintained, there is a method of calculating by using the following equations (16) to (19) on the basis of the principle of Fourier analysis. When the encoder 5 is normally operating, an estimated error Δθe of the electric angle takes a value close to zero. However, if the encoder 5 has malfunctioned, it becomes a signal having a sawtooth waveform of the same cycle as the electric angle frequency. Therefore, an amplitude SR thereof can be extracted by using Fourier analysis calculation using, as a basis, a sine-wave signal calculated on the basis of the estimated electric angle. If the amplitude SR is equal to or larger than a threshold, it is determined that the encoder has a fault. In the calculation represented by the equations (16) to (19), because major calculation is integration, the method is less susceptible to high-frequency disturbances and has less erroneous detection.

Δθₑ=θe−θₑ_{_}ₑₛₜ (16)

SA=∫Δθₑ·cos(θₑ_{_}ₑₛₜ)·dt (17)

SB=∫Δθₑ·sin(θₑ_{_}ₑₛₜ)·dt (18)

SR=\sqrt{SA²+SB²} (19)

In the configuration of FIG. 2-3, the electric angle frequency 113 is input to the determination unit 114. However, similar effects can be obtained by inputting thereto the estimated electric-angle frequency 103 instead.

When the electric angle frequency 113 is input to the determination unit 114, if the encoder signal 6 is maintained at a value at the time of a fault due to an encoder fault other than a disk displacement, the motor speed cannot be detected and zero speed is output. At this time, the determination unit 114 cannot perform a switching operation from the electric angle frequency 113 to the estimated electric-angle frequency 103, thereby becoming stuck.

Therefore, by having the configuration in which the estimated electric-angle frequency 103 is input to the determination unit 114, such a state of being stuck can be avoided.

As described above, by having the configuration in which the electric angle frequency to be used for estimation of the electric angle can be switched between the estimated electric-angle frequency 103 and the electric angle frequency 113 calculated from the encoder signal 6, estimation of the electric angle can be continued even when there is a fault other than a disk displacement fault, thereby enabling a fault to be detected.

### INDUSTRIAL APPLICABILITY

The motor control device according to the present invention is useful for a motor control device that controls a synchronous motor, and is particularly suitable for a motor control device used as a source of a driving force of a robot or a feed mechanism.

### REFERENCE SIGNS LIST

1, 1a synchronous motor control device, 2 inverter, 3 current detection unit, 4 motor, 5 encoder, 6 encoder signal, 7 speed conversion unit, 8 electric-angle conversion unit, 9 electric angle, 10 speed signal, 11 speed command unit, 12 speed command, 13 speed control unit, 14 current command, 15 current control unit, 16 voltage command, 17 coordinate transformation unit, 18 voltage command, 19 PWM processing unit, 20 switching command, 21 detected current signal, 22 coordinate transformation unit, 23 detected current signal, 24, 24a electric-angle estimation unit, 25 estimated electric angle, 26 switching unit, 27 coordinate-transformed electric angle, 100 current estimation-error calculation unit, 101 current estimation error, 102 adaptive identification unit, 103 estimated electric-angle frequency, 104 shaft-misalignment correction unit, 105 correction signal, 106 post-correction estimated electric-angle frequency, 107 integration unit, 108 coordinate transformation unit, 109 coordinate transformation unit, 110 voltage command, 111 detected current signal, 112 gain, 113 electric angle frequency, 114 determination unit, 115 instruction signal, 116 electric-angle-frequency switching unit, 117 electric-angle estimation-calculation electric-angle frequency.

1. A motor control device that controls a synchronous motor that does not have a salient-pole property, the motor control device comprising:
a motor electric-angle detection unit that detects an electric angle of a motor on a basis of an output signal of an encoder connected to the motor that is a synchronous motor and outputs a detected motor electric angle;
a motor electric-angle estimation unit that receives a motor voltage of the motor and a motor current of the motor, estimates an electric angle of the motor on a basis of the motor voltage and the motor current, and outputs an estimated motor electric angle; and
a switching unit that receives the detected motor electric angle and the estimated motor electric angle, determines whether the encoder is operating normally on a basis of the detected motor electric angle and the estimated motor electric angle, outputs the detected motor electric angle when the encoder is operating normally, and outputs the estimated motor electric angle when the encoder is not operating normally.

2. The motor control device according to claim 1, wherein when an error between the detected motor electric angle and the estimated motor electric angle is equal to or larger than a threshold, and a state where the error between the detected motor electric angle and the estimated motor electric angle is equal to or larger than the threshold continues for equal to or more than a threshold time, the switching unit determines that the encoder is not operating normally.

3. The motor control device according to claim 1, further comprising a motor-speed detection unit that detects a speed of the motor on a basis of the output signal of the encoder and that outputs a detected motor speed of the motor, wherein
the motor electric-angle estimation unit receives the detected motor speed, and
when an absolute value of a frequency of the detected motor electric angle or a frequency of the estimated motor electric angle is less than a threshold, the motor electric-angle estimation unit outputs the estimated motor electric angle by using the detected motor speed.
